(19) United States
(12) Patent Application Publication
(10) Pub. No.: US 2025/0074753 A1
(43) Pub. Date: Mar. 6, 2025

(54) LIFTING DEVICE

(71) Applicant: EUROGAMMA S.P.A., Calenzano (Florence) (IT)

(72) Inventors: Paolo BARBAGALLO, Calenzano (Florence) (IT); Antonio BARBAGALLO, Calenzano (Florence) (IT)

(21) Appl. No.: 18/727,890

(22) PCT Filed: Jan. 9, 2023
(86) PCT No.: PCT/IB2023/050163

§ 371 Date: Jul. 10, 2024

(30) Foreign Application Priority Data
Jan. 13, 2022 (IT) 102022000000491

(51) Int. Cl. B66F 7/28

(52) U.S. Cl. CPC B66F 7/28

(57) ABSTRACT

Described is a lifting device including a base support and a column fixed on said base support, a trolley sliding vertically on said column designed to engage with a load to be lifted and comprising a first lower portion, a second portion and a reticular connecting structure.

### TECHNICAL FIELD

This invention relates to a lifting device.

In particular, the invention relates to a lifting device of the column type of the type used for lifting vehicles or in any case bulky objects.

### BACKGROUND ART

The lifting devices of the column type are divided between those with an electro-mechanical drive and those with an electro-hydraulic drive.

This type of column lifting device is very widespread because it occupies little space on the ground and is often provided with wheels for moving them freely (when not under load) inside the work space.

Prior art electro-mechanical lifting devices generally use electric motors connected, for example, to a worm screw.

On the other hand, those with an electro-hydraulic drive use a hydraulic piston lifting system.

The lifting devices comprise a column structure on which a trolley slides.

The trolley is connected to the drive means (worm screws or pistons) in such a way as to impart the lifting action to the object to be lifted.

The trolley is the element of the device designed to engage, entering into direct contact, with a load to be lifted.

The trolley is, therefore, the element designed to support the load to be lifted, discharging the forces onto the column of the device.

The trolley is made as a single part, or in any case using a hyperstatic structure, and is engaged on the column by four rollers or alternatively four skids.

The four rollers, or skids, are engaged, free to slide on their own axis, in respective guides made directly on the column.

The trolley made in one piece and the presence of four rollers or skids generally determine a system for connection to the hyperstatic column.

This hyperstatic system does not allow optimum use of the four rollers or skids.

In fact, due to manufacturing tolerances of the column as well as deformations during use of the column under load, of the total of four rollers or skids only three will always and without doubt be loaded whilst one will only be loaded in a random manner.

This major drawback of the prior art devices means that during the design phase the four rollers or skids must be sized as if there were only three (the ones actually always under load).

It is understood that this design translates into an inefficient oversizing of the rollers or skids and their supports, that is to say, a non-optimum use of all the components of the prior art lifting device.

An embodiment of a prior art lifting device is described in WO94/29550.

### AIM OF THE INVENTION

The aim of the invention is therefore to overcome the drawbacks of the prior art.

A first aim of the invention is therefore to provide a lifting device which uses in an optimised manner the load on all the rollers or skids present in the trolley.

A further aim is to provide a lifting device which is able to adapt to many conditions of use (different maximum loads which can be lifted) without the need to replace the entire trolley but only some components of it.

The above-mentioned aims are achieved by a lifting device comprising the technical features described in one or more of the appended claims.

Further features and advantages of the invention are more apparent in the non-limiting description which follows of a preferred embodiment of a lifting device according to the invention.

### BRIEF DESCRIPTION OF THE DRAWINGS

The description is set out below with reference to the accompanying drawings which are provided solely for purposes of illustration without restricting the scope of the invention and in which:

FIG. 1 is a schematic side view of a lifting device according to the invention;

FIG. 2 is a partly cross-sectioned schematic side view of a lifting device according to the invention.

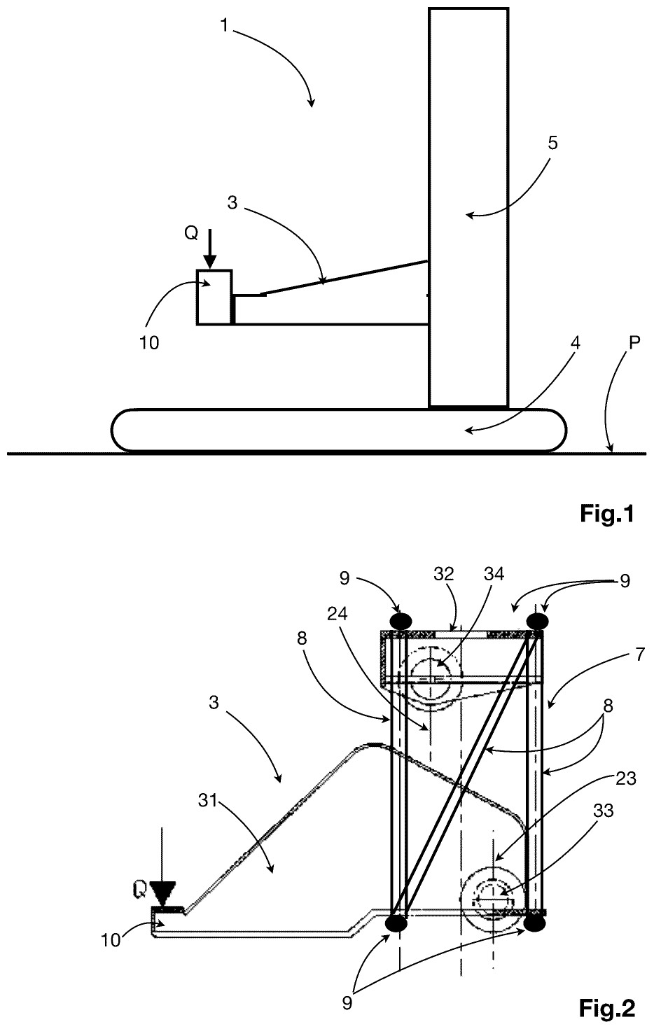

### DETAILED DESCRIPTION

The reference numeral 1 generically denotes a lifting device according to the invention, hereinafter also referred to merely as the device 1.

With reference to the accompanying drawings, the lifting device 1 according to the invention comprises a base support 4 configured to be positioned on a horizontal plane P.

The support 4 advantageously comprises wheels designed to allow a user to move the device 1 on the plane P.

The movement can also be facilitated with the aid of automatic or semi-automatic movement means such as, for example, forklift trucks or transpallets.

In the case of use of movement means the device 1 advantageously comprises, at the support 4, portions for safely engaging them, for example linear guides where to insert the forks of the forklift trucks or transpallets.

The lifting device 1 according to the invention also comprises a column 5 which is fixed on the base support 4 in such a way as to be positioned perpendicular to the horizontal plane P.

In detail, according to the operating configuration, the base support 4 is positioned on a substantially horizontal plane P and the column is, therefore positioned vertically relative to the plane P.

The device 1 also comprises a trolley 3 which is operatively connected to the column 5 and slidable vertically on it.

The trolley 3 is designed to engage with a load Q to be lifted.

Advantageously, in order to make the lifting of the load Q more stable and secure, the trolley comprises engagement means 10.

The engagement means 10 are at the end of the trolley 3 opposite to that operatively connected to the column 5.

The trolley 3 therefore adopts a cantilever shape connected with the column 5.

According to the invention, and as shown in FIG. 2, the trolley 3 comprises a first lower portion 31 and a second upper portion 32.

The first portion 31 and the second portion 32 comprise respective rollers 33, 34 which engage in respective tracks 23, 24 made in the column 5.

According to the embodiment illustrated in the drawings, in detail, the first lower portion 31 comprises a respective pair of rollers 33 and the second upper portion 32 comprises a respective pair of rollers 34.

Advantageously, the respective pairs 33, 34 of rollers are aligned with each other in pairs in a horizontal plane (perpendicular to the vertical axis of the column 5.

The tracks 23, 24 act as guides to control the vertical sliding of the trolley 3 along the height of the column 5.

The tracks 23, 24 are made in one piece with the structure of the column 5 or, advantageously, consist of independent components fixed to the column 5.

According to this second embodiment, the tracks 23, 24 can be made of materials different from that of the column 5, further optimising the wear and the ease of sliding of the rollers or skids 33, 34 on them.

The tracks 23, 24, as shown in FIG. 2, are advantageously formed on the column in such a way that both face towards the trolley.

The trolley 3 also comprises a reticular connecting structure 7 designed to connect the first lower portion 31 and the second upper portion 32.

The reticular structure 7 comprises tie rods and struts 8, as shown in a possible solution in FIG. 2.

Due to its very nature, the reticular structure 7, thanks to its elasticity, allows an effect to be obtained of compensating the position, under load, of the first lower portion 31 with respect to the second upper portion 32 of the trolley 3.

Advantageously, moreover, the tie rods and the struts 8 are connected to the first lower portion 31 and to the second upper portion 32 by respective hinges 9.

The hinges 9 for connecting between the tie rods and the struts 8 of the reticular structure 7 and the respective portions 31, 32 are of the type with at least one degree of freedom.

Advantageously, the hinges 9 comprise ball joints with two or more degrees of freedom.

The presence of the above-mentioned connecting hinges 9 makes it possible to further optimise the effect of compensating the position, under load, of the first lower portion 31 than the second upper portion 32 of the trolley 3 already obtained by adopting the reticular structure 7 as such.

The particular configuration of the trolley 3 of a lifting device 1 according to the invention allows, by using tie rods and struts 8, the first portion 31 and the second portion 32 to be standardised to different conditions of use and load capacity.

In particular, it is possible to vary only the size and/or the material and/or the quantity of tie rods and struts 8 to adapt the device 1 to different loads Q to be lifted.

This considerably reduces the production and storage management costs of the device 1 itself.

In effect, by keeping the first 31 and the second 32 portion unaltered for the various uses it is sufficient to have available different types of tie rods and struts 8 to meet different design requirements.

The elasticity of the reticular structure 7 and, if necessary, the presence of the connecting hinges 9 makes it possible to obtain a system in which the first portion 31 and the second portion 32 can rotate and move relative to each other in a horizontal plane in such a way as to guarantee in any condition (for example deformations of the column 5) the perfect load on all the rollers 33, 34 present in the device 1 according to the invention.

The invention therefore achieves the preset aims and brings significant advantages overcoming the drawbacks of the prior art.

1. A lifting device comprising:
a base support configured to be arranged on a horizontal plane and a column fixed on said base support in such a way that it is arranged perpendicular to said horizontal plane,
a trolley which can slide vertically on said column designed to engage with a load to be lifted, said trolley comprising a first lower portion and a second upper portion, said first portion and said second portion comprising respective rollers engaging in respective tracks made in said column, said trolley also comprising a reticular structure for connecting said first lower portion and second upper portion, said reticular structure comprising tie rods and struts; characterised in that said tie rods and struts are connected to said first lower portion and said second upper portion by respective hinges, said hinges being of the type with at least one degree of freedom.

2. The device according to claim 1, wherein said hinges comprise spherical joints.

3. The device according to claim 1, wherein said first lower portion comprises a respective pair of rollers.

4. The device according to claim 1, wherein said second upper portion comprises a respective pair of rollers.

5. The device according to claim 1, wherein said trolley comprises on one end thereof an engagement means with said load to be lifted.

6. The device according to claim 1, wherein said reticular structure is of the lattice type.

7. The device according to claim 1, wherein said base support comprises wheels designed to allow the movement of said device on said plane.
